(19) United States
(12) Patent Application Publication
(10) Pub. No.: US 2017/0209998 A1
(43) Pub. Date: Jul. 27, 2017

(54) MULTIPLE FUNCTION TOOL

(71) Applicant: Ronald Mongiello, Thousand Oaks, CA (US)

(72) Inventor: Ronald Mongiello, Thousand Oaks, CA (US)

(21) Appl. No.: 15/411,940

(22) Filed: Jan. 20, 2017

Related U.S. Application Data
(60) Provisional application No. 62/281,518, filed on Jan. 21, 2016.

(51) Int. Cl. B25F 1/04; G10K 5/00; B25B 23/18; B25B 13/06; B25G 1/10

(52) U.S. Cl. CPC B25F 1/04; B25B 13/06; B25G 1/102; B25B 23/18; G10K 5/00

(57) ABSTRACT

Workers who are engaged in working on equipment often require specialized equipment beyond the regular screwdrivers, pliers and wrenches. Through trial and error certain tools have been found to be invaluable, most of those combining multiple functions into a single tool. More options in a single tool mean fewer tools and lighter loads but each industry has its unique fasteners, usually to prevent unauthorized access to dangerous or proprietary equipment, such as electrical vaults and electronic hardware. Some of these tools, such as the Leatherman, are known across industries.

### CROSS-REFERENCE TO RELATED APPLICATIONS

Applicant claims priority from a previously filed and pending U.S. Provisional Application No. 62/281,518 filed on Jan.21, 2016 for a “Multi-tool used in the railroad industry to combine five tools into one” by inventor Ronald Mongiello.

### BACKGROUND

Workers who are engaged in working on equipment often require specialized equipment beyond the regular screwdrivers, pliers and wrenches. Through trial and error certain tools have been found to be invaluable, most of those combining multiple functions into a single tool. More options in a single tool mean fewer tools and lighter loads but each industry has its unique fasteners, usually to prevent unauthorized access to dangerous or proprietary equipment, such as electrical vaults and electronic hardware. Some of these tools, such as the Leatherman, are known across industries.

### SUMMARY

Embodiments relate to tool that contains at least 2 unique tools that are required for use in the same industry including at least one tool that is unique to a particular industry. Embodiments can also relate to the ability for the tool to include a lighting source and a safety identifier. The singular body that encompasses the embodiments is designed to enable maximum torque by the user in inclement weather or when grease or foreign bodies prevent a firm grasp of the tool. Compactness of body is important but yet having the ability to extend to reach is functionally important as well.

These and other features, aspects and advantages of the present invention will become understood with reference to the following description, appended claims and accompanying figures.

### BRIEF DESCRIPTION OF THE DRAWINGS

FIG. 1 shows a left side oblique profile view of the multiple function tool, according to an embodiment with the socketed portion in the collapsed position and the tool in the closed position.

FIG. 2 shows a left side rear oblique view of the multiple function tool, according to an embodiment with the socketed portion in the collapsed position and the tool in the closed position.

FIG. 3 shows a lower oblique profile view of the multiple function tool, according to an embodiment with the socketed portion in the collapsed position and the tool in the closed position.

FIG. 4 shows a left side oblique profile view of the multiple function tool, according to an embodiment with the socketed portion in the extended position with tool in open position.

FIG. 5 shows a lower oblique profile view of the multiple function tool, according to an embodiment with the socketed portion in the extended position with tool in open position.

FIG. 6 shows a frontal profile view of the multiple function tool, according to an embodiment with the socketed portion in the extended position with a cross-sectional line cutting through to show detail of FIG. 7.

FIG. 7 shows a cross-sectional view as detailed from FIG. 6 of the multiple function tool, according to an embodiment with the socketed portion in the collasped position with tool in closed position.

FIG. 8 shows a frontal profile view of the multiple function tool, according to an embodiment with the socketed portion in the extended position with an obliquely angled cross-sectional line cutting through to show detail of FIG. 9.

FIG. 9 shows a cross-sectional view as detailed from FIG. 8 of the multiple function tool, according to an embodiment with the socketed portion in the collapsed position with tool in closed position.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

This current invention covers the field of application where users are required to use a specific set of tools for a series of related job tasks. In one instance, a set of tools used for people that construct, maintain and repair railroad signal equipment is disclosed where specific sizing of nut drivers are used along with an industry specific EPost tool. One or more embodiments may have usage is in the field of safety for people working around trains includes a railroad whistle which is a requirement for those working near a railroad and the use of a illumination device, such as a flashlight, is required for lighting of a work surface or signaling. Other embodiments have one or more tools having the capability to extend, thereby increase the reach of the tool. Other embodiments may have usage as well, other types of nut drivers and tools can be used. The current state of the art does not exist for such an apparatus that is capable of holding an at least one industry specific tool (such as an EPost Tool in this instance.) along with common.

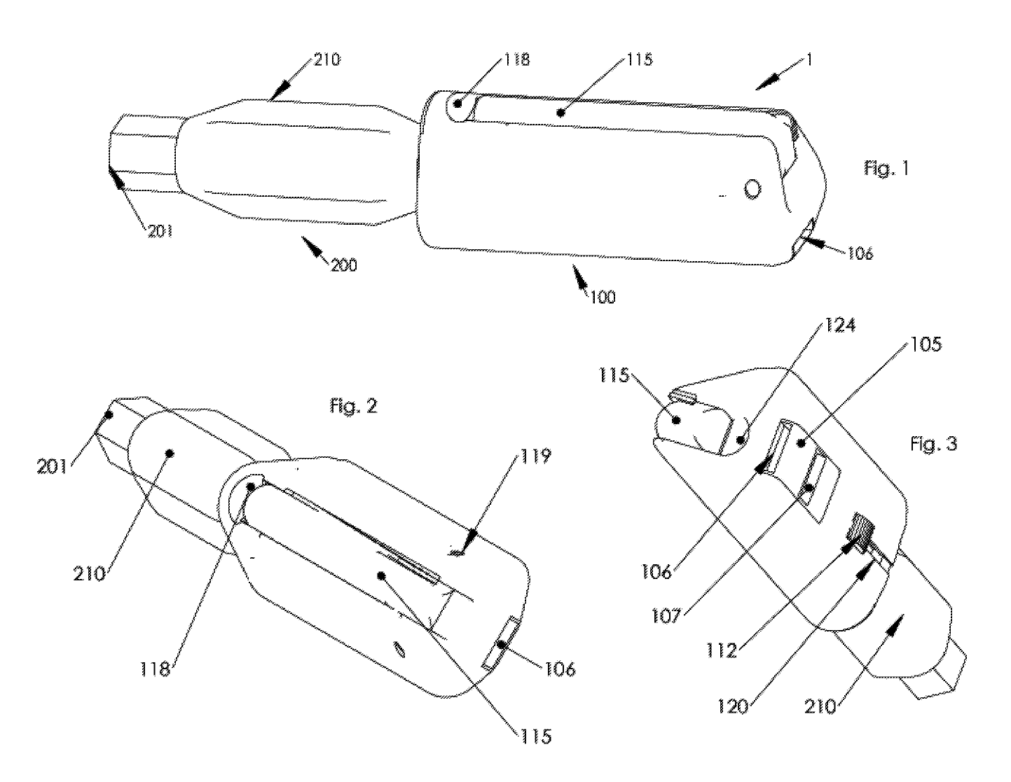

FIG. 1 shows an device 1 with its two principle components, open socket portion 200, having a proximal end 202 and a distal end 201 and cradle component 100, which have been conjoined through internal guide socket 102. Open socket portion 200 is a hollow cylindrical rod having an interior surface 204 and an exterior surface 205, said surfaces are not necessarily shaped in similar fashions. Cradle 100 has a geometrically defined polygonal exterior 103 and a cylindrical internal passage 104, said passage 104 being adapted to receive bore 102. Bore 102 can be a separate piece inserted into passage 104 or said passage can be shaped into the exact sizing for bore 102. Bore 102 is shaped congruently with open socket portion 200 and is designed to slidably accept the insertion of socket portion 200 into the interior of bore 102 as detailed in FIG. 5. Said cradle 100 has a proximal end 140 and a distal end 130.

Geometrically defined exterior 103 is defined to enhance the gripability of the tool alone with also providing additional leverage for increased torque from the user. In this embodiment, a three sided exterior is used to maximize the amount of torque can the user can exert and maintain a steady grip, especially with the user is wearing heavy gloves or when grease, grime or other surface elements are present that enhance slippage. The disclosure of the 3 sided exterior surface is not a limiting factor and other multi-faced alternatives will be suitable for this apparatus. A minimal number of sides is also preferred to prevent the tool from rolling away from the operator when it is set down after usage. Another advantage of the usage of the minimal number of sides is to differentiate the tool from others in the tool box or tool belt as from a tactical selection of tools. Often tools are selected “blindly” in toolboxes or tool belts and also at night.

Integral to the exterior 103 is an embodiment that incorporates a safety whistle 105 into the tool 1. In this disclosure, whistle 105 is located on the proximal end of cradle 140, but the location is not limited to only being located along said end 140. Federal regulations, in particular Safe Practices for Wayside Rail Transit Worker Protection and OSHA Rules for Confined Space Environments mandate that certain safety equipment is mandated for use by workers who work in occupations where it is noisy or where many different sounds are confined in a small area. A high decibel whistle is mandated along with the use of high visibility safety vests or steel tipped boots. FIG. 3 shows the whistle 105 is integral to a surface of exterior 103 having a pneumatic air entrance 106 which allows for flow into chamber 108 exiting through whistle exhaust 107.

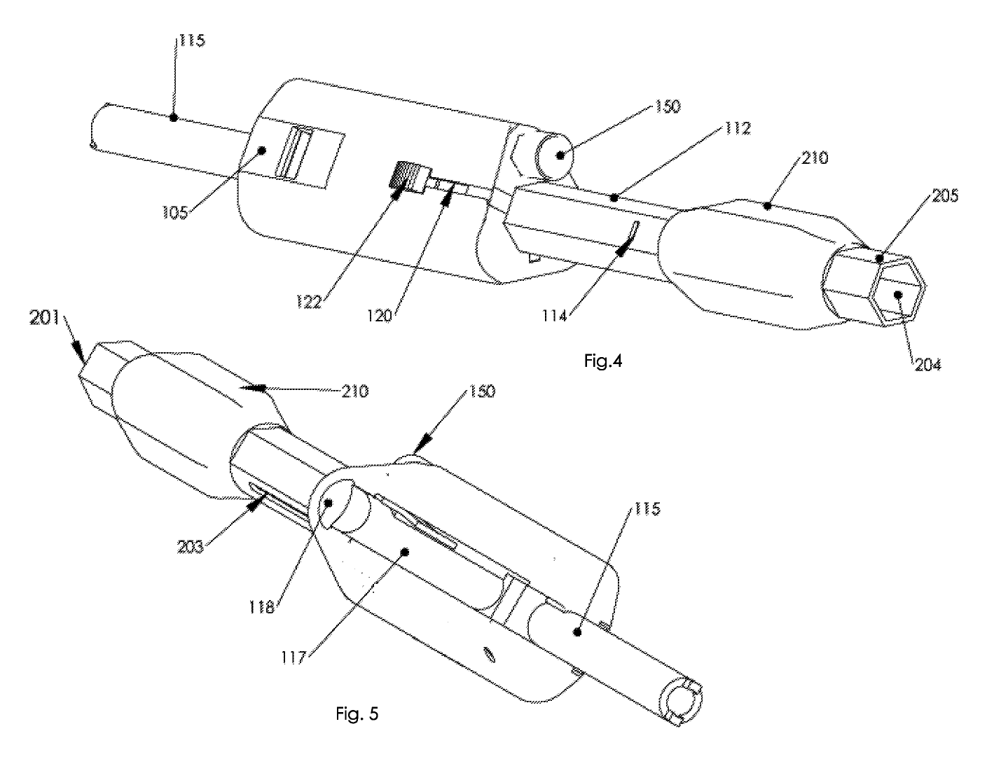

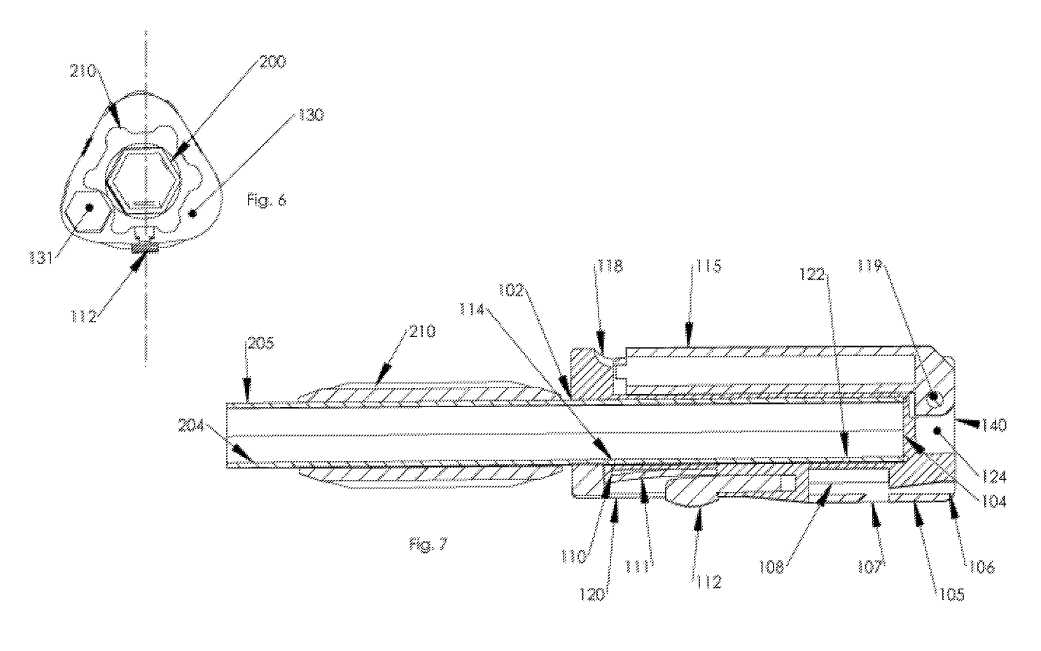

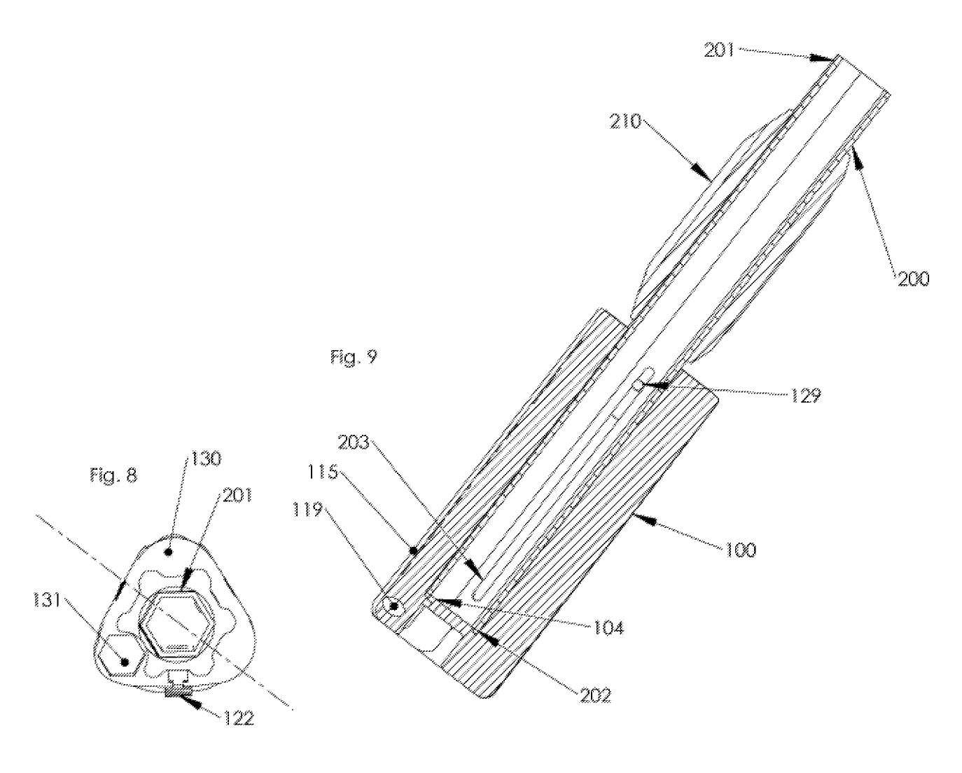

Additionally FIG. 6 details the means for moving open socket portion 200 between the collapsed state as detailed in FIGS. 1, 2 and 3 and the extended position as detailed in the socket portion FIGS. 4 and 5. Located along one of the sides of cradle 100 is socket securement means which is used to prevent the linear movement of the socket portion 200 while engaged in the bore 102. In this disclosure, the securement means is a button 112. Button 112 is located inside of securement button slot 120 through which slides securement button 112. A tactile engagement means are used for the user to be able to blindly identify and operate the moving of said socket portion. In this disclosure, the tactile engagement means is a raised button, but the disclose is not limited to a particular size or style of identify and operating the securement means. Button 112 protrudes outwardly from slot 120 and is greater in height than the surrounding surfaces as seen in FIGS. 6 and 8 said slot and the protrusion has a textured surface, shown in FIG. 3 as a series of raised ridges, which increases the tactical recognition of the component and also increases the friction between the users digit and the button in cases of excess grease, moisture or grime. When button 112 is slidably relocated along slot 120 the button slides along paw lever arm 111, where said arm 111 has a natural reverse bias as detailed in FIG. 7 in the relaxed position. Perpendicular to distal end of arm 111 is paw 121. Paw 121 extends through passage 104 and into bore 102 and engages into either forward stop 114 or rear stop 122 located along the same axis on socket portion 200. Stops 114 and 122 are designed to accept paw 121 with sufficient engagement that will prevent the movement of socket portion 200 along bore 102. In this disclosure, stops 114 and 122 are through-holes but detents could also be used. Also, there is no limitation as to the number of stops placed along said bore 102. As button 112 is slid forward along slot 120, paw lever arm 111 is depressed causing paw 121 to deflect downwardly. As button 1123 is slid rearwardly, paw level arm is is released causing the natural bias of the arm 111 to rise allowing paw 121 to disengage with stops 114 or 122.

Hingedly attached tool 115 is located on the proximal end 140 of cradle 100. Tool 115 when not in use, is located along the one of the edges of the geometrically defined exterior 103 in tool receiver section 117 as detailed in FIG. 4 with the tool in the open position. Pin 119 connects the proximal end of tool 115 to cradle 100 and allows for movement of tool 115 along an arc defined by the length of the tool. Catchlock 123 provides a stop limiting the travel of tool 155 along said arc to be approximately 180 degree and provides stability to the tool in the open position. Relief 124 located on the proximal surface 140 allows for the distal end of tool to rotate about pin 119. In an embodiment, tool 115 can be slideable attached to cradle 100 through a grooved slot that would be received by a corresponding rail in receiver 117, though this embodiment is not shown. Digit access cutout 118 allows for the user to insert a digit or another tool to access the distal end of tool 115 to facilitate its removal from receiver 117. There is a friction fit between the walls of receiver 117 and the exterior surface of tool 115 which prevents the accidental displacement of tool 115 into the extended position as seen in FIGS. 4 and 5. FIG. 1 shows that tool 115 once replaced into receiver 117 does not protrude above the natural edges of cradle 100. In this disclosure, distal end of tool 115 is adapted with a Post Tool design 116 which is a unique tool to Railroad Signal Equipment. This disclosure is not limited to a specific tool or type of industry.

An embodiment of device 1, includes an internal bore 131 which extends inwardly from distal surface 130. FIG. 8 details one location for a cylindrical bore 131 but there is no limitation as to location so long as the bore 131 is located along the surface of 130. Bore 131 is designed to accept variety of devices including a flashlight 150 as detailed in FIG. 5, a spot laser or any other device that is required by the user. Bore 131 is shown as being polygonal in shape in this disclosure, but this disclosure does not limit the shape of bore in any way.

Socket portion 200 slidably interconnects with cradle 100 through bore 102. FIG. 9 details the interior of socket portion 200 where stud 129 rides in socket slot 203 which allows for both smooth linear travel of the socket along bore 102 as the socket portion is extended and allows for anti-rotational torqueing forces placed on the socket during use. Slot 203 shares a common axis with the major longitudinal axis of said socket 200. Distal end 201 of socket 200 is adapted to a particular size of nut or screw cap that is unique to a particular application. It is desired in this disclosure that the shape of end 201 be greater than the nominal standard sizes for a particular socket size. This will allow for an easier task of locating the tool onto the nut or screw cap and prevents the “rounding over” of the edges of the nut or screw cap as well.

The use of this tool 1 can be in several configurations as the user can use the socket portion in the collapsed position for close-in work where space is limited or the user can extend the socket portion for greater reach. The user extends socket to the extended position by depressing button 112 and sliding it into a rearward position thereby allowing paw 121 to disengage from said stops while the user is grasping the ribbed gripping segment 210 and slidably relocating the socket portion into an extended position where said paw reengages into desired said stop. Grip 210 can also be used for applications where guiding of the socket portion 200 or stabilizing the socket portion 200 is necessary. In this disclosure, said grip 210 has 6 protruding ribs extending form a central axis common to the axis of socket portion 200. There are no limitations as to the size, type or configuration of the grip, so long as the operator has a means for gripping the socket during use and extension/collapsing of the socket portion. FIGS. 6 and 8 detail the 6 sided configuration of the distal end 201 that matches common fasteners such as bolt and nut configurations. Said distal end 201 and proximal end 202 of socket portion 200 in this disclosure are of similar shape and size, but there are no limiting in this disclosure to a particular shape and size for either said proximal or said distal end of socket portion 200. This disclosure details a single set of tool and socket sizes that will interface with common screws, nuts, bolts and enclosures specific to the railroad signal equipment, but there is are no limiting the type, size and style of the tools, tool tip, socket configuration and socket sizing in this disclosure.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device comprising:
a cradle portion comprising a polygonal exterior portion with multiple angled sides having a proximal end and a distal end and an interior portion with a cylindrical bore, said bore having an entrance at said distal end, said bore being centrally located along the longitudinal axis of said cradle portion said end, said exterior portion being adapted to receive external devices; and
a socket portion comprising of a hollow cylindrical rod having an interior surface and an external surface and a distal end shaped to receive socket head fasteners and a proximal end where said socket portion slidably engages said cradle portion through said cylindrical bore.

2. The device of claim 1, wherein said socket portion contains an anti-rotational travel slot along extending from said external surface to said internal surface along an axis common to the longitudinal axis of said socket portion, said anti-rotational travel slot integrates with a stud located on said internal portion of said cradle, said stud capable of fitting inside of said slot where said stud prevents rotational movement of said socket portion.

3. The device of claim 1, wherein said socket portion has at least two stopping detents located along said external surface along a common axis, said detents are integrated with a tactical engagement means and a biased paw to engage in said detents whereby said paw engages with said detents thereby preventing linear movement of said socket through said cylindrical bore.

4. The device in claim 1 wherein said socket portion has a gripping segment whose principle axis is coincident with the longitudinal axis of said socket portion and said gripping segment is adjacent to said proximal end of said socket portion

5. The device in claim 1 wherein said exterior surface of said cradle is adapted to contain a sound producing device with a described shaped entrance, a resonance chamber and shaped exit, which is capable of producing a high decimal sound when pneumatic forces are applied to said entrance.

6. A device comprising:
a cradle portion comprising a polygonal exterior portion with multiple angled sides having a proximal end and a distal end and an interior portion with at least one cylindrical bore having an entrance at said distal end, where one of said bores are centrally located along the longitudinal axis of said cradle portion said end, said exterior portion being adapted to receive external devices; and
a socket portion comprising of a hollow cylindrical rod having an interior surface and an external surface and a distal end shaped to receive socket head fasteners and a proximal end where said socket portion slidably engages said cradle portion through a said cylindrical bore.

7. The device of claim 6, wherein said socket portion contains an anti-rotational travel slot along extending from said external surface to said internal surface along an axis common to the longitudinal axis of said socket portion, said anti-rotational travel slot integrates with a stud located on said internal portion of said cradle, said stud capable of fitting inside of said slot where said stud prevents rotational movement of said socket portion.

8. The device of claim 6, wherein said socket portion has at least two stopping detents located along said external surface along a common axis, said detents are integrated with a tactical engagement means and a biased paw to engage in said detents whereby said paw engages with said detents thereby preventing linear movement of said socket through said cylindrical bore.

9. The device in claim 6 wherein said socket portion has a gripping segment whose principle axis is coincident with the longitudinal axis of said socket portion and said gripping segment is adjacent to said proximal end of said socket portion

10. The device in claim 6 wherein said exterior surface of said cradle is adapted to contain a sound producing device with a described shaped entrance, a resonance chamber and shaped exit, which is capable of producing a high decimal sound when pneumatic forces are applied to said entrance.

11. The device in claim 6 where an illumination device is capable of insertion into one of said bores.

12. A device comprising:
a cradle portion comprising a polygonal exterior portion with multiple angled sides having a proximal end and a distal end and an interior portion with at least one cylindrical bore having an entrance at said distal end, where one of said bores are centrally located along the longitudinal axis of said cradle portion said end, said exterior portion being adapted to receive external devices; and
a socket portion comprising of a hollow cylindrical rod having an interior surface and an external surface and a distal end shaped to receive socket head fasteners and a proximal end where said socket portion slidably engages said cradle portion through a said cylindrical bore.

13. The device of claim 12, wherein said socket portion contains an anti-rotational travel slot along extending from said external surface to said internal surface along an axis common to the longitudinal axis of said socket portion, said anti-rotational travel slot integrates with a stud located on said internal portion of said cradle, said stud capable of fitting inside of said slot where said stud prevents rotational movement of said socket portion.

14. The device of claim 12, wherein said socket portion has at least two stopping detents located along said external surface along a common axis, said detents are integrated with a tactical engagement means and a biased paw to engage in said detents whereby said paw engages with said detents thereby preventing linear movement of said socket through said cylindrical bore.

15. The device in claim 12 wherein said exterior surface of said cradle is adapted to contain a sound producing device with a described shaped entrance, a resonance chamber and shaped exit, which is capable of producing a high decimal sound when pneumatic forces are applied to said entrance.

16. The device in claim 12 wherein said exterior portion of said cradle contains an tool receiver section, said section designed to allow for a tool to be rotatably attached thereto, said tool being secured by a catchlock at maximum rotation.

17. The device in claim 12 where an illumination device is capable of insertion into one of said bores.
